(19) United States
(12) Patent Application Publication
(10) Pub. No.: US 2023/0183997 A1
(43) Pub. Date: Jun. 15, 2023

(54) AIR FILTERING SHELTER

(71) Applicant: PHILIP MORRIS PRODUCTS S.A., Neuchâtel (CH)

(72) Inventors: Ricardo Cali, Mannheim (DE); Tobias Lipp, Santiago de Compostela (ES)

(73) Assignee: PHILIP MORRIS PRODUCTS S.A., Neuchâtel (CH)

(21) Appl. No.: 17/925,093

(22) PCT Filed: May 10, 2021
(86) PCT No.: PCT/IB2021/053970

§ 371 Date: Nov. 14, 2022

(30) Foreign Application Priority Data
May 12, 2020 (EP) 20174195.6

(51) Int. Cl. E04H 15/14; E04H 15/38; F24F 7/003; F24F 7/06; F24F 13/28; F24F 8/108; F24F 8/22; F24F 11/00

(52) U.S. Cl. CPC E04H 15/14; E04H 15/38; F24F 7/003; F24F 7/06; F24F 13/28; F24F 8/108; F24F 8/22; F24F 11/0001; F24F 2110/50

(57) ABSTRACT

An air filtering shelter 100 comprising a shelter frame 110 comprising a plurality of frame members 112 defining a sheltered area 102. Filter media 120 extends across the plurality of frame members 112, where the filter media 120 is disposed over the sheltered area 102. An airflow guide 130 extends across the plurality of frame members 112 between the sheltered area 102 and the filter media 120. The airflow guide 130 is impermeable and the filter media 120 and the airflow guide 130 define an airflow channel 125 between them. An airflow generator 140-1 is coupled to the shelter frame 110. The airflow generator 140-1 has an inlet 142 in the airflow channel 125 and an outlet 144 in the sheltered area 102.

The present disclosure relates to an air filtering shelter that efficiently filters ambient air that passes into a sheltered area defined by the shelter.

A number of types of air filtering device have been proposed in the art that are configured to filter the air around an individual. For example, there are child carriers that offer some filtration capabilities for the air around a child positioned in the carrier. These types of systems have a filter element where airflow is generated through the filter element and directed towards the breathing area of the child.

One known published U.S. patent application, US20200063429 discloses a portable room including sides and a roof attached to the multiple sides. Pockets are integrated in the roof. Air filters may be inserted in the pockets. The air filter may be used to filter the air exiting the portable room or entering the portable room.

According to aspects of the present invention, there is provided an air filtering shelter. The shelter has a shelter frame. The shelter frame comprises a plurality of frame members about a sheltered area. A filter media extends across the plurality of frame members, wherein the filter media is disposed over the sheltered area. An airflow guide extends across the plurality of frame members between the sheltered area and the filter media, where the airflow guide is impermeable. The filter media and the airflow guide define an airflow channel between them. An airflow generator is coupled to the shelter frame. The airflow generator has an inlet in the airflow channel and an outlet in the sheltered area.

The air filtering shelter may have a shelter frame. The shelter frame may comprise a plurality of frame members. The frame members may be disposed about a sheltered area. A filter media may extend across the plurality of frame members. The filter media may be disposed over the sheltered area. An airflow guide may extend across the plurality of frame members between the sheltered area and the filter media. The airflow guide may be impermeable. The filter media and the airflow guide may define an airflow channel between them. An airflow generator may be coupled to the shelter frame. The airflow generator may have an inlet in the airflow channel. The airflow generator may have an outlet in the sheltered area. In some embodiments multiple airflow generators may be components of the shelter.

Some configurations consistent with those described above may advantageously protect individuals within the sheltered area from pollution in the ambient environment. By disposing the filter media over the sheltered area and coupling the filter media to the frame members of the shelter frame, the filter media may attain a significantly larger surface area for filtration than the surface area of filter media in a typical filtration element for a sheltered area. The larger surface area may advantageously increase the filtration capacity of the system. The larger surface area may advantageously decrease the pressure drop across the filter media. A decreased pressure drop may extend the useful life of the filter media.

In some examples the shelter disclosed herein is generally configured to filter air that enters the sheltered area defined by the shelter. The shelter may be collapsible, such as for storage. The shelter may be expandable, such as for use. In embodiments, the shelter is repeatably collapsible and expandable for repeated use and storage. The shelter may be a variety of types of shelters such as a tent, an umbrella, or a canopy, as examples. The sheltered area may be a fully contained area, such as where the shelter is a tent. The sheltered area may be a partially contained area, such as where the shelter is a canopy or an umbrella. The sheltered area may define a portion of a larger enclosure. For example, the sheltered area may be a canopy over at least a portion of an enclosure such as a vehicle compartment or a stroller compartment.

As mentioned above, the shelter has a shelter frame with a plurality of frame members defining a sheltered area. The shelter frame may be collapsible to a collapsed state and expandable to an erected state. In various embodiments, the plurality of frame members define the sheltered area in the erected state. The shelter frame may be manually collapsible and expandable. The shelter frame may be collapsible and expandable by a motor drive. In some embodiments, the shelter frame may be collapsible and expandable by both manual intervention and a motor drive. The shelter frame may be collapsible and expandable by either manual intervention or a motor drive. In some embodiments the shelter frame may be at least a portion of a collapsible tent frame.

In at least the expanded state, a plurality of the frame members are coupled. The plurality of frame members may be detachably coupled, in some embodiments. The frame members may be coupled to define the expanded state, and detached to define the collapsed state. The plurality of frame members may be pivotably coupled to at least one pivot joint. In some such examples, the plurality of frame members may have a first end pivotably coupled to a first pivot joint, and a second end pivotably coupled to a second pivot joint. In some such embodiments, the first pivot joint may be positioned on one end of the sheltered area, and the second pivot joint may be positioned on an opposite end of the sheltered area. The first pivot joint and the second pivot joint may mutually define a pivot axis of the plurality of frame members. In some such embodiments, the plurality of frame members may be pivoted about the pivot axis in a first direction to define an expanded configuration. The plurality of frame members may be pivoted about the pivot axis in a second direction to define a collapsed position.

In some embodiments, multiple pivot axis may be defined. A first plurality of frame members may be coupled to pivot joints defining a first pivot axis, and a second plurality of frame members may be coupled to pivot joints defining a second pivot axis. In some embodiments, a first plurality of frame members are detachably coupled at connector joints and a second plurality of frame members are coupled to at least one pivot joint. In some such embodiments, some frame members may be both detachably coupled at a connector joint and coupled to at least one pivot joint.

The frame members may be constructed of a variety of types of materials and combinations of materials. The frame members may be semi-flexible rods, poles, and bars. When in an expanded position, the plurality of frame members may be structurally rigid to support materials forming the walls of the shelter. The frame members may be constructed of a thermosetting plastic. In some embodiments the frame members are constructed of a carbon fiber composite. In some embodiments the frame members are constructed of aluminium. In some embodiments the frame members are constructed of wood or bamboo. The frame members may be constructed of fiberglass. The frame members may be constructed of steel. Other materials for constructing the frame members or combinations of the above mentioned materials are certainly contemplated. The frame members may have a variety of dimensions and orientations. The frame members may have a maximum width ranging from 5-25 mm; 7-20 mm; or 10-15 mm. The frame members may have a maximum depth ranging from 5-25 mm; 7-20 mm; or 10-15 mm. The frame members generally have a length extending between a first end and a second end. In some embodiments the frame members may taper towards the first end and the second end.

As mentioned above, the filter media may extend across a plurality of frame members. In some embodiments, the filter media defines an outer surface of the shelter. The filter media may define an outer wall of the shelter. The filter media may be disposed over the sheltered area. The filter media may be in contact with ambient air surrounding the shelter. In some embodiments, the filter media is coupled to a component that is coupled to the frame members. The filter media may be coupled to the airflow guide around one or more frame members. In some embodiments the filter media is coupled to one or more frame members. The filter media may be coupled to an outer surface of one or more frame members. The filter media may be coupled to an inner surface of each of the plurality of frame members. The filter media may be coupled to the frame members with adhesive, heat or ultrasonic welding, fasteners such as bolts, and the like. In some examples the filter media is detachable from the shelter frame. In such examples the filter media may be coupled directly or indirectly to the shelter frame with snap connections, hook-and-loop fasteners, magnets, straps, and the like. Such a configuration may advantageously facilitate maintenance of the filter media. Maintenance of the filter media may include cleaning or replacing the filter media.

In various implementations, it is not necessary that the filter media extend across every frame member that forms the shelter. In some embodiments, the filter media extends across two frame members. The filter media may extend across three or more frame members. The filter media may have a surface area about equal to the surface area of the shelter. The filter media may have a surface area that is more than half of the surface area of the shelter. In some examples, the filter media may have a surface area ranging from 0.01 to 5 m². The filter media may have a surface area ranging from 0.1 to 2 m². The filter media may have a surface area ranging from 0.1 to 0.5 m². The filter media may have a surface area ranging from 0.1 to 0.2 m².

The filter media may be constructed of a variety of different types of materials and combinations of materials. As mentioned above, maintenance of the filter media may include cleaning the filter media. Cleaning the filter media may dislodge debris from the filter media. The filter media may be cleaned through shaking the filter media. The filter media may be cleaned through vacuuming the filter media. The filter media may be cleaned through washing the filter media. In such examples the filter media may be washable. Such a configuration advantageously extends the useful life of the filter media. Washable filter media may advantageously reduce the waste that is typically associated with replacing filters of filtration systems. The filter media may have an air permeability of 10 to 10,100 litres per second per square meter. More preferably, the filter media may have an air permeability of 101-1,260 litres per second per square meter. The filter media may be a textile material. In some embodiments the filter media is a composite of multiple layers of textile materials. The filter media may be a laminate of layers of textile materials. The filter media may be a combination of multiple layers of filter media. In examples, the filter media may include polypropylene fibers. In some such embodiments the filter media may include polypropylene microfibers.

The airflow guide may be configured to direct air from the filter media into the sheltered area. In some embodiments, the airflow guide defines an inner surface of the shelter. The airflow guide may define an outer boundary of the sheltered area. The airflow guide may form an inner wall of the shelter. The airflow guide may be configured to obstruct airflow from the filter media directly into the sheltered area. The airflow guide may be configured to obstruct airflow from the sheltered area to the ambient environment through the filter media. In various implementations, it is not necessary that the airflow guide extend across every frame member that forms the shelter. In some embodiments, the airflow guide extends across two frame members. The airflow guide may extend across three or more frame members. The airflow guide may have a surface area that is equal to the surface area of the filter media. The airflow guide may have a surface area that is greater than the surface area of the filter media. The surface area of the airflow guide may range from 0.01 to 5 m². The airflow guide may have a surface area ranging from 0.1 to 2 m². The airflow guide may have a surface area ranging from 0.1 to 0.5 m². The airflow guide may have a surface area ranging from 0.1 to 0.2 m². In some embodiments the airflow guide has a surface area of less than 0.2 m².

The airflow guide may be disposed over the sheltered area. The airflow guide may be coupled to the shelter frame directly or indirectly. In some embodiments, the airflow guide and the filter media are coupled to each other around two or more frame members. In some embodiments the shelter frame is disposed between the airflow guide and the filter media. In some embodiments the airflow guide and the filter media surround the shelter frame. In some embodiments, the airflow guide is coupled to two or more frame members. The airflow guide may be coupled to an outer surface of one or more frame members. The airflow guide may be coupled to an inner surface of one or more frame members. The airflow guide may be coupled directly or indirectly to the frame members with adhesive, heat or ultrasonic welding, fasteners such as bolts, and the like. In some examples the airflow guide is detachably coupled to the shelter frame. In such examples the airflow guide may be coupled to the shelter frame with snap connections, hook-and-loop fasteners, magnets, straps, and the like. Such a configuration may advantageously facilitate maintenance of the airflow guide. Maintenance of the airflow guide may include cleaning or replacing the airflow guide.

The airflow guide may be constructed of various types of materials and combinations of materials. The airflow guide generally has a lower air permeability than the filter media. In some embodiments, the airflow guide is a generally impermeable material. The airflow guide may be a textile material. The airflow guide may be fabric. The airflow guide may be polypropylene fabric.

As mentioned above, the airflow guide and the filter media may define an airflow channel between them. The airflow channel may extend from the filter media to the sheltered area. Ambient air may extend from the ambient environment through the filter media into the airflow channel. In some embodiments where the shelter frame is disposed between the airflow guide and the filter media, the frame members may be positioned within the airflow channel. The airflow channel may have a depth that is defined by the distance between the filter media and the airflow guide. The airflow channel may have a depth of at least 5 mm. The airflow channel may have a depth up to 30 mm. The airflow channel may have a depth ranging from 5 mm to 25 mm. The airflow channel may have a depth ranging from 10 mm to 20 mm. The volume of the airflow channel may be at least 1 litre. The volume of the airflow channel may be less than 10 litres. The volume of the airflow channel may range from 2 to 8 litres. The volume of the airflow channel may range from 2.5 to 5 litres. In some embodiments, the volume of the airflow channel may range from 2.5 to 3.5 litres.

In some embodiments, in a collapsed state, the shelter may have one or more shelter components that define a portion of the airflow channel. The one or more shelter components may be coupled to configured the shelter in its expanded state. Each of the one or more shelter components may include a frame member. Each of the one or more shelter components may include a portion of the airflow guide. Each of the one or more shelter components may include a portion of the filter media. The portion of the airflow channel may be defined between the filter media and the airflow guide. In some such examples, each shelter component may be configured to be coupled to an abutting shelter component that defines an abutting portion of the airflow channel. In an expanded configuration, the shelter component may have a sealing means that is configured to form at least a partial seal with the abutting shelter component about the abutting portion of the airflow channel. For example, in examples where one or more shelter components have a portion of the airflow guide, the abutting portions of the airflow guides may be configured to sealably couple. Abutting portions of the airflow guides may be configured to sealably couple through the use of magnets, hook-and-loop fastener, a zipper, clamps, and the like.

The airflow generator may be configured to generate airflow from the ambient environment through the filter media and into the sheltered area. As discussed above, the airflow generator may be coupled to the shelter frame. The airflow generator may be detachable and attachable to the shelter frame. In some embodiments the airflow generator is fixed to the shelter frame. The airflow generator may be disposed in the airflow channel. The airflow generator may have an inlet positioned in the airflow channel. The airflow generator may have an outlet positioned in the sheltered area. The airflow generator may have an outlet positioned in an opening defined by the airflow guide. The airflow generator may be a fan.

The airflow generator may be a centrifugal fan or impeller fan having a radially-directed air inlet and an axially-directed outlet. The airflow generator may have a plurality of fan blades that are configured to draw air into the air inlet and expel air through the air outlet. The fan blades may be configured to rotate about a fan axis. In some embodiments, the airflow generator may be an axial fan. In such embodiments the airflow generator may be disposed in an opening defined by the airflow guide such that its axial inlet is positioned in the airflow channel and its axial outlet is positioned in the sheltered area.

In some embodiments, a filter element may be positioned to extend across the inlet of the airflow generator. The filter element may be a second filtration stage of the shelter. Such a configuration may improve the overall filtration efficiency of the system compared to single-stage filtration systems. In some embodiments the filter element is coupled to the airflow generator about the inlet. The filter element may be detachable from the airflow generator. The filter element generally incorporates second filter media, where the “first” filter media is considered the filter media extending across the plurality of frame members. The filter element may be a high efficiency particulate air (HEPA) filter element. In some embodiments the filter element may be an adsorbent filter such as a carbon filter. The filter element may incorporate multiple layers of filter media. The filter element may be replaceable by a user. The filter element may be washable by a user.

The shelter may have an ultraviolet light (UV) source. The UV light source may be configured to emit UV light in the airflow channel. The UV light source may be configured to emit UV light between the first filter media and the second filter media. The UV light source may be configured to emit UV light between the filter media and an outlet of the airflow generator. The UV light source may be positioned to emit UV light to air passing through the inlet of the airflow generator. In some such embodiments, the UV light source may be coupled to the airflow generator at its inlet. The UV light source may be positioned between the filter media and the airflow guide. The UV light source may be coupled to the shelter frame. Using a UV light source may advantageously neutralize or limit the growth of microbes in the air. Neutralizing or limiting the growth of microbes may purify the air. The UV light source may advantageously limit the exposure of individuals within the shelter to microbes. The UV light source may be positioned in the airflow channel. The UV light source may emit UV-C light. The UV light source may emit UV light at a wavelength from 240 to 290 nanometers, more preferably from 250 to 280 nanometers, and even more preferably from 260 to 275 nanometers.

The airflow generator may be in operative communication with a power source. In embodiments incorporating a UV light source, the power source may be in operative communication with the UV light source. The power source may be a battery. The power source may be a rechargeable power source. In some such embodiments, the power source may define a port that is configured to receive a charging cable such as a universal serial bus (USB) cable. The port of the power source may be configured to couple to a micro-USB or USB-C cable for recharging. The power source may be a replaceable power source.

In some embodiments the airflow generator is configured to receive a battery. In some embodiments incorporating a UV light source, the UV light source is configured to receive a battery. The UV light source may have a separate power source from the airflow generator, in some embodiments. In some embodiments the shelter may be configured to couple to the power source. The power source may be coupled to the shelter for example by using hook-and-loop fasteners, zip fasteners, magnets, ties, or combinations thereof. The shelter may have a pocket that is configured to receive the power source. The pocket may be coupled to the airflow guide. The pocket may be coupled to an inner surface of the airflow guide within the sheltered area. The pocket may be coupled to the shelter frame, in some embodiments.

The shelter may comprise an air quality sensor. The air quality sensor may be disposed in the sheltered area. Such a configuration may advantageously allow the shelter to monitor air quality. The air quality sensor may identify if the air quality is below a threshold. The air quality sensor may be in operative communication with the airflow generator. The air quality sensor may be in operative communication with the airflow generator through a controller. In some embodiments, the air quality sensor may operate the airflow generator upon sensing air quality that is below a threshold. Such a configuration may advantageously reduce energy that would otherwise be wasted to operate the airflow generator and other components when air filtration is unnecessary. In some embodiments the air quality sensor may be configured to identify gaseous constituents in the sheltered area. In some such embodiments the air quality sensor may operate the airflow generator upon detection of a particular constituent in the air. The air quality sensor may operate the airflow generator upon detection of a particular concentration of a particular constituent in the air. Constituents in the air may include CO₂, CO and O₂, as examples. The air quality sensor may operate the airflow generator upon detection of particles of a particular size in the air.

The shelter may have a communication module, in a variety of embodiments. The communication module may be configured to inform a user of air quality in the sheltered area. The communication module may be in data communication with the air quality sensor. The communication module may include a user interface. The user interface may have a variety of configurations and may have various components and combinations of components. The user interface may include a screen coupled to the air purification device. The screen may be configured to provide a visual notification to a user. The user interface may include a speaker coupled to the air purification device. The speaker may provide an audio notification to a user. The user interface may include a wireless communication component configured to communicate with a user device such as a laptop, smartphone, iPhone, speaker, or other devices. The user interface may send data directly to a user device, or to a database that may be accessed by a user or a home automation system through a network.

According to aspects of the present invention, there is provided a method. The method comprises drawing air through a filter media. The method comprises drawing air into an airflow channel defined between the filter media and an airflow guide. The method comprises passing the air from the airflow channel through an airflow generator. The method comprises passing the air to a sheltered area defined by the airflow guide.

The method may comprise drawing air through a filter media. The method may comprise drawing air into an airflow channel defined between the filter media and an airflow guide. The method may comprise passing the air from the airflow channel through an airflow generator. The method may comprise passing the air to a sheltered area defined by the airflow guide.

Methods consistent with those described above may advantageously protect individuals within the sheltered area from pollution in the ambient environment. Furthermore, the above methods may increase the surface area of the filter media that may be used for filtration compared to the surface area of filter media in prior art filter elements, which may have advantages as discussed above.

The method may comprise manually collapsing the filter media and the airflow guide. Such a configuration advantageously allows the shelter to be stored easily. The method may comprise pivoting a plurality of frame members coupled to the filter media and the airflow guide, wherein pivoting the plurality of frame members is about one or multiple pivot joints. Such a method may provide a simplified approach to erecting and collapsing the filter media and the airflow guide. The method may comprise detaching the filter media from a plurality of frame members about the sheltered area. Such a step may simplify maintenance operations, such as replacing the filter media. The method may comprise cleaning the filter media. Cleaning the filter media may comprise washing the filter media. Washing the filter media may have advantages as discussed above. The method may comprise exposing the air to UV light in the airflow channel. Exposing air to UV light has advantages that have been discussed above. The method may comprise sensing air quality within the sheltered area. The air quality may be sensed by an air quality sensor, as has been discussed above. The method may comprise reporting air quality to a user interface. The method may comprise operating the airflow generator upon sensing air quality outside of an air quality threshold. In accordance with some methods, passing the air through the airflow generator may comprise directing the air through a filter element.

As used herein, the singular forms “a,” “an,” and “the” also encompass embodiments having plural referents, unless the content clearly dictates otherwise.

The words “preferred” and “preferably” refer to embodiments of the invention that may afford certain benefits, under certain circumstances. However, other embodiments may also be preferred, under the same or other circumstances. Furthermore, the recitation of one or more preferred embodiments does not imply that other embodiments are not useful and is not intended to exclude other embodiments from the scope of the disclosure, including the claims.

Any direction referred to herein, such as “top,” “bottom,” “left,” “right,” “upper,” “lower,” and other directions or orientations are described herein for clarity and brevity but are not intended to be limiting of an actual device or system. Devices and systems described herein may be used in a number of directions and orientations.

The phrase “filter media” is used herein to mean a physical substance that is used to filter. Filter media may incorporate filter textiles, particulates, membranes, screens, and combinations thereof.

A “filter element” is defined herein as a solid article incorporating filter media that is designed to be installed and periodically replaced in a filtration system to filter a fluid.

A “microbe” is a microorganism or a microbial agent that may invade and replicate within a cell of an organism. A microbe may include, but is not limited to, bacteria, viruses, protozoa, archaea and fungi.

“Upstream” and “downstream” are terms that refer to the direction or location relative to the direction of fluid flow along a fluid flow path, where “downstream” is the direction in which the fluid is configured to flow and “upstream” is the direction from which the fluid is configured to arrive from.

A “textile” is a flexible material constructed of an interconnected network of fibers. The fibers may be interconnected through weaving, knotting, felting, knitting, and crocheting, as examples.

“Collapsible” is defined as the ability of the structure to be repeatedly reduced to a more compact volume such as for carrying or storing. Collapsible includes the ability to fold, detach, or both fold and detach frame members of the structure without causing damage to the structure.

“Expandable” is defined as the ability of the structure to be repeatedly erected to define a larger volume, such as for use of the structure. Expandable includes the ability to unfold, couple, or both unfold and couple the frame members of the structure without damage to the structure.

“Microfibers” are fibers having a diameter of less than 10 micrometres.

“Washable” is defined as the ability of a material to be agitated and rinsed with water without damage to the material.

A “thermosetting plastic” is a polymer that is initially malleable and then irreversibly hardened in a particular configuration through a curing operation.

“Impermeable” is defined herein as having an air permeability of less than 1000 cubic centimetres of gas per square meter of material per 24 hour period at 1 atmosphere and at a temperature of 22.8 degrees Celsius.

The technology disclosed herein is generally configured to improve the air quality in a sheltered area. In various embodiments, the technology disclosed herein relates to a shelter that incorporates an air filtration system. The structure of the shelter itself may form portions of the filtration system. An outer wall of the shelter may be formed of filter media, which allows the filter media to have as large a surface area as the outer surface of the shelter itself. Such a large surface area allows the shelter to have a high filtration capacity.

The shelter may form an airflow channel extending from the filter media to the sheltered area defined by the shelter. An airflow generator may be a component of the shelter that is configured to generate airflow along the airflow channel. An airflow guide and the filter media may form the airflow channel between them. The airflow guide may be impermeable to prevent airflow from the filter media from passing directly to the sheltered area. The airflow guide may form the outer boundary of the sheltered area, such as an inner wall of the shelter.

The shelter may filter the air in multiple stages. The filter media forming an outer surface of the shelter may be a first stage. A filter element coupled to an inlet of the airflow generator may be a second stage. The filter element may be a particle filter, and adsorbent filter, or a particle filter and an adsorbent filter. Another filtration stage may use a UV light source to purify the air.

The invention is defined in the claims. However, below there is provided a non-exhaustive list of non-limiting examples. Any one or more of the features of these examples may be combined with any one or more features of another example, embodiment, or aspect described herein.

Example Ex1 An air filtering shelter comprising: a shelter frame comprising a plurality of frame members defining a sheltered area; a filter media extending across the plurality of frame members, wherein the filter media is disposed over the sheltered area; an airflow guide extending across the plurality of frame members between the sheltered area and the filter media, wherein the airflow guide is impermeable and the filter media and the airflow guide define an airflow channel between them; and an airflow generator coupled to the shelter frame, wherein the airflow generator has an inlet in the airflow channel and an outlet in the sheltered area.

Example Ex2 The air filtering shelter of example Ex1, wherein the shelter frame is collapsible to a collapsed state and expandable to an erected state.

Example Ex3 The air filtering shelter of example Ex2, wherein the shelter frame is manually collapsible and expandable.

Example Ex4 The air filtering shelter of any one of examples Ex2 or Ex3, wherein the shelter frame is collapsible and expandable by a motor drive.

Example Ex5 The air filtering shelter of example Ex2, wherein in the erected state the air filtering shelter defines the sheltered area.

Example Ex6 The air filtering shelter of any one of examples Ex1 to Ex5, wherein the plurality of frame members are pivotably coupled to at least one pivot joint.

Example Ex7 The air filtering shelter of any one of examples Ex1 to Ex6, wherein the filter media is coupled to an outer surface of one or more frame members.

Example Ex8 The air filtering shelter of any one of examples Ex1 to Ex7, wherein the airflow guide is coupled to an inner surface of one or more frame members.

Example Ex9 The air filtering shelter of any one of examples Ex1 to Ex8, wherein the filter media is a textile material.

Example Ex10 The air filtering shelter of any one of examples Ex1 to Ex9, wherein the filter media comprises polypropylene microfibers.

Example Ex11 The air filtering shelter of any one of examples Ex1 to Ex10, wherein the filter media is coupled to the plurality of frame members.

Example Ex12 The air filtering shelter of example Ex11, wherein the filter media is detachable from the plurality of frame members.

Example Ex13 The air filtering shelter of any one of examples Ex1 to Ex12, wherein each of the the plurality of frame members comprises a thermosetting plastic.

Example Ex14 The air filtering shelter of any one of examples Ex1 to Ex13, wherein the airflow guide comprises polypropylene fabric.

Example Ex15 The air filtering shelter of any one of examples Ex1 to Ex14, further comprising an ultraviolet (UV) light source configured to emit UV light into the airflow channel.

Example Ex16 The air filtering shelter of any one of examples Ex1 to Ex15, further comprising a rechargeable power source in operative communication with the airflow generator.

Example Ex17 The air filtering shelter of any one of examples Ex1 to Ex15, further comprising a replaceable power source in operative communication with the airflow generator.

Example Ex18 The air filtering shelter of any one of examples Ex1 to Ex17, further comprising an air quality sensor disposed in the sheltered area, wherein the air quality sensor is in operative communication with the airflow generator.

Example Ex19 The air filtering shelter of any one of examples Ex1 to Ex18, further comprising a filter element coupled to the airflow generator about the inlet.

Example Ex20 The air filtering shelter of any one of examples Ex1 to Ex19, wherein the air filtering shelter defines a canopy.

Example Ex21 The air filtering shelter of any one of examples Ex1 to Ex20, wherein the air filtering shelter defines a stroller compartment.

Example Ex22 The air filtering shelter of any one of examples Ex1 to Ex19, wherein the air filtering shelter defines a tent.

Example Ex23 A method of filtering air comprising: drawing air through a filter media into an airflow channel defined between the filter media and an airflow guide; and passing the air from the airflow channel through an airflow generator to a sheltered area defined by the airflow guide.

Example Ex24 The method of example Ex23, further comprising manually collapsing the filter media and the airflow guide.

Example Ex25 The method of any one of examples Ex23 to Ex24, further comprising pivoting a plurality of frame members coupled to the filter media and the airflow guide, wherein pivoting the plurality of frame members is about a pivot joint.

Example Ex26 The method of any one of examples Ex23 to Ex25, further comprising detaching the filter media from a plurality of frame members about the sheltered area.

Example Ex27 The method of any one of examples Ex23 to Ex26, further comprising washing the filter media.

Example Ex28 The method of any one of examples Ex23 to Ex27, further comprising exposing the air to UV light in the airflow channel.

Example Ex29 The method of any one of examples Ex23 to Ex28, further comprising sensing air quality within the sheltered area.

Example Ex30 The method of example Ex29, further comprising reporting air quality to a user interface.

Example Ex31 The method of any one of examples Ex29 and Ex30, further comprising operating the airflow generator upon sensing air quality outside of an air quality threshold.

Example Ex32 The method of any one of examples Ex23 to Ex31, wherein passing the air through the airflow generator comprises directing the air through a filter element.

Examples will now be further described with reference to the figures in which:

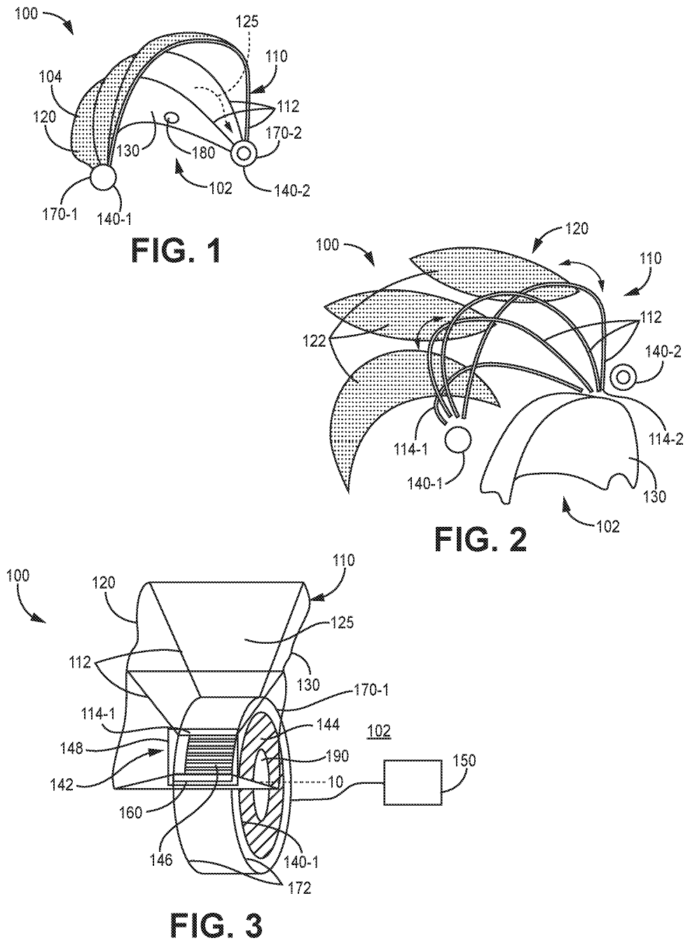

FIG. 1 is an example air filtering shelter;

FIG. 2 is an exploded view of the example air filtering shelter; and

FIG. 3 is a perspective detail view of a portion of the air filtering shelter.

FIG. 1 depicts one example air filtering shelter 100 that is consistent with the current disclosure and FIG. 2 depicts an example exploded view of the example air filtering shelter of FIG. 1. The shelter 100 defines a sheltered area 102. The example shelter 100 is generally configured to filter ambient air that enters the sheltered area 102. The shelter 100 is generally collapsible, such as for storage. The shelter 100 is generally expandable, such as for use as a shelter. In embodiments, the shelter 100 is repeatably collapsible and expandable for repeated use and storage. The shelter may be a variety of types of shelters such as a tent, an umbrella, or a canopy, as examples. In this example, the shelter 100 is a canopy, which form a portion of a larger contained area. In some other embodiments, the sheltered area 102 may be a fully contained area, such as where the shelter is a tent.

Ambient air passes through the walls of the air filtering shelter 100 and is filtered before reaching the sheltered area 102. The air filtering shelter 100 has a shelter frame 110. The shelter frame 110 has a plurality of frame members 112. The frame members 112 are disposed about the sheltered area 102. The frame members 112 form the underlying structure of the shelter 100. The frame members 112 may be constructed of a variety of types of materials and combinations of materials. The frame members 112 may be semi-flexible rods, poles, and bars. When in an expanded position, the plurality of frame members 112 may be structurally rigid to support materials forming the walls of the shelter. The frame members 112 may be constructed of materials as have been discussed in detail above.

The filter media 120 is disposed over the sheltered area 102. The filter media defines an outer surface 104 of the shelter 100. The filter media 120 extends across the plurality of frame members 112. In some embodiments, the filter media 120 defines an outer surface 104 of the shelter. The filter media 120 may be disposed over the sheltered area 102. The filter media 120 is in direct contact with ambient air surrounding the shelter 100. In some embodiments, the filter media 120 is coupled to another component that is coupled to the frame members. The filter media 120 may be coupled to the airflow guide 130 around one or more frame members of the plurality of frame members 112. In some embodiments the filter media 120 is coupled to one or more frame members of the plurality of frame members 112. The filter media 120 may be coupled to an outer surface of one or more frame members. In some embodiments the filter media 120 is fixed to the frame members 112. In such embodiments, filter media 120 may be coupled to the frame members 112 with adhesive, heat or ultrasonic welding, fasteners such as bolts, and the like. In some examples the filter media 120 is detachable from the shelter frame 110. In such examples the filter media 120 may be coupled directly or indirectly to the shelter frame 110 with snap connections, hook-and-loop fasteners, magnets, straps, and the like. Such a configuration may advantageously facilitate maintenance of the filter media 120 such as cleaning or replacing the filter media 120.

In various implementations, it is not necessary that the filter media 120 extend across every frame member of the plurality of frame members 112 that form the shelter 100. In the current example, the filter media 120 is formed from multiple segments of filter media 122. Each segment of filter media 122 extends across two frame members of the plurality of frame members 112. In some alternate embodiments, the segments of filter media 122 may extend across three or more frame members of the plurality of frame members 112. The filter media 120 may have a total surface area about equal to the outer surface area of the shelter 100. The filter media 120 may have a surface area that is more than half of the outer surface area of the shelter 100. The filter media 120 may have surface areas that have been discussed in detail above.

The filter media 120 may be constructed of a variety of different types of materials and combinations of materials, examples, configurations, and properties of which have been described in detail, above. Also, as mentioned above, the filter media 120 may be washable. Such a configuration advantageously extends the useful life of the filter media 120. Washable filter media may advantageously reduce the waste that is typically associated with replacing filters of filtration systems.

Some configurations consistent with those described above may advantageously protect individuals within the sheltered area 102 from pollution in the ambient environment. By disposing the filter media 120 over the sheltered area 102 and coupling the filter media 120 to the frame members 112 of the shelter frame 110, the filter media 120 may have a significantly larger surface area for filtration than the surface area of filter media in a typical filtration element for a sheltered area. The larger surface area may advantageously increase the filtration capacity of the system. The larger surface area may advantageously decrease the pressure drop across the filter media 120. A decreased pressure drop may extend the useful life of the filter media 120.

The airflow guide 130 extends across the plurality of frame members 112 between the sheltered area 102 and the filter media 120. The airflow guide 130 is configured to guide air that has passed through the filter media 120 to the sheltered area 102. In particular, the airflow guide 130 is configured to guide air from the filter media 120 to the airflow generators 140-1, 140-2. The airflow guide 130 is configured to obstruct airflow directly from the filter media 120 to the sheltered area 102. The airflow guide 130 is configured to obstruct airflow from the sheltered area 102 to the ambient environment through the filter media 120. As such, the airflow guide 130 may generally be air impermeable. In some embodiments the airflow guide 130 is substantially air impermeable. In the current example, the airflow guide 130 defines an inner surface of the shelter 100. In particular, the airflow guide 130 defines an outer boundary of the sheltered area 102.

In the current example, the airflow guide 130 extends across each of the plurality of frame members 112. In some other implementations, it is not necessary that the airflow guide extend across every frame member that forms the shelter. In some embodiments, the airflow guide extends across two frame members. The airflow guide may extend across three or more frame members. The airflow guide may have a plurality of airflow guide segments, similar to the filter media 120 shown here. The airflow guide 130 may have a surface area that is equal to the surface area of the filter media 120. The airflow guide 130 may have a surface area that is greater than the surface area of the filter media. The airflow guide 130 may have a surface area consistent with the surface areas discussed above.

The airflow guide 130 may be disposed over the sheltered area 102. The airflow guide 130 may be coupled to the shelter frame 110 directly or indirectly. In some embodiments, the airflow guide 130 and the filter media 120 are coupled to each other around two or more frame members of the plurality of frame members 112. In this example, the shelter frame 110 is disposed between the airflow guide 130 and the filter media 120. In some embodiments the airflow guide 130 and the filter media 120 surround the shelter frame 110. In some embodiments, the airflow guide 130 is coupled to two or more frame members of the plurality of frame members 112. In this example, the airflow guide 130 is coupled to an inner surface of one or more frame members of the plurality of frame members 112. The airflow guide 130 may be coupled directly or indirectly to the frame members 112 with adhesive, heat or ultrasonic welding, fasteners such as bolts, and the like. In some examples the airflow guide is detachably coupled to the shelter frame 110. In such examples the airflow guide 130 may be coupled to the shelter frame with snap connections, hook-and-loop fasteners, magnets, straps, and the like. Such a configuration may advantageously facilitate maintenance of the airflow guide 130. Maintenance of the airflow guide 130 may include cleaning or replacing the airflow guide.

The airflow guide 130 may be constructed of various types of materials and combinations of materials. The airflow guide 130 generally has a lower permeability than the filter media. In some embodiments, the airflow guide 130 is an impermeable material. The airflow guide 130 may be a textile material. The airflow guide 130 may be fabric. The airflow guide 130 may be polypropylene fabric.

An airflow channel 125 is defined between the filter media 120 and the airflow guide 130. The airflow channel 125 is configured to accommodate airflow from the filter media 120 to the sheltered area 102. The airflow channel 125 may extend from the filter media 120 to the sheltered area 102. Ambient air may extend from the ambient environment through the filter media 120 into the airflow channel 125. In this example, the plurality of frame members 112 are disposed in the airflow channel 125. The airflow channel 125 may have configurations and parameters as have been discussed above.

FIG. 3 is a perspective detail view of a portion of the air filtering shelter of FIGS. 1 and 2. FIG. 3 depicts the first airflow generator 140-1 coupled to the shelter frame 110. In particular, in the current example, a first airflow generator 140-1 is coupled to the shelter frame on a first side, and a second airflow generator 140-2 is coupled to the shelter frame 110 on a second side (visible in FIGS. 1 and 2). The second airflow generator 140-2 and the first airflow generator 140-1 may be substantially similar. In some alternate embodiments a second airflow generator 140-2 is omitted.

The first airflow generator 140-1 defines an inlet 142 in the airflow channel 125. The first airflow generator 140-1 defines an outlet 144 in the sheltered area 102. The first airflow generator 140-1 is generally configured to generate airflow from the ambient environment through the filter media 120 and into the sheltered area 102. In the current example, the first airflow generator 140-1 is coupled to the shelter frame 110. In some embodiments, the first airflow generator 140-1 may be detachable and attachable to the shelter frame 110. In some embodiments the first airflow generator 140-1 is fixed to the shelter frame 110. The first airflow generator 140-1 may be at least partially disposed in the airflow channel 125.

In the current example, the first airflow generator 140-1 is a fan. In particular, the first airflow generator 140-1 is a centrifugal fan or impeller fan having a radially-directed air inlet 142 and an axially-directed outlet 144. The first airflow generator 140-1 has a plurality of fan blades 146 that are configured to draw air into the air inlet 142 and expel air through the air outlet 144. The fan blades are configured to rotate about a fan axis 10. In some other embodiments the first airflow generator 140-1 may be an axial fan. In such embodiments the first airflow generator may be disposed in an opening defined by the airflow guide 130 such that its axial inlet is positioned in the airflow channel 125 and its axial outlet is positioned in the sheltered area 102.

Although transparent in the current image, a filter element 148 (depicted as transparent for visibility of other components) may be positioned to extend across the inlet 142 of the first airflow generator 140-1. The filter element 148 may be a second filtration stage of the shelter 100. Such a configuration may improve the overall filtration efficiency of the shelter 100 compared to single-stage filtration systems. In some embodiments the filter element 148 is coupled to the first airflow generator 140-1 about the inlet 142. The filter element 148 may be detachable from the first airflow generator 140-1. The filter element 148 generally incorporates second filter media. The second filter media may be constructed of materials and have properties as have been discussed above.

The first airflow generator 140-1 is generally in operative communication with a power source 150, which is shown schematically in FIG. 3. The second airflow generator 140-2 (FIG. 1) may also be coupled to the power source 150. Alternatively, the second airflow generator 140-2 may have its own power source. The power source 150 may include a battery, such as in a battery pack. The power source 150 may be a rechargeable power source. In some such embodiments, the power source 150 may define a port that is configured to receive a charging cable such as a universal serial bus (USB) cable, which has been discussed above. The power source 150 may be a replaceable power source such a disposable battery. The power source 150 may be coupled to the shelter 100 through a variety of approaches as have been discussed above. The shelter 100 may have a pocket that is configured to receive the power source 150. The pocket may be coupled to the airflow guide 130. The pocket may be coupled to an inner surface of the airflow guide 130 within the sheltered area 102. The pocket may be coupled to the shelter frame 110, in some embodiments.

The shelter 100 may have an ultraviolet light (UV) source 160 in various embodiments. The UV light source 160 may be configured to emit UV light in the airflow channel. The UV light source 160 may be configured to emit UV light between the first filter media 120 and the outlet 144 of the first airflow generator 140-1. The UV light source 160 may advantageously neutralize or limit the growth of microbes in the air from the airflow channel 125. Neutralizing or limiting the growth of microbes in the airflow channel 125 may purify the air in the sheltered area 102. In the current example, the UV light source 160 is coupled to the first airflow generator 160a at the inlet 162. The UV light source 160 is positioned to emit UV light to air passing through the inlet 142 of the first airflow generator 140-1. In some other embodiments the UV light source 160 may be positioned in the airflow channel 125. Particularly, the UV light source 160 may be positioned between the filter media 120 and the airflow guide 130. In some other embodiments the UV light source may be positioned at the outlet 144 of the airflow generator 140-1. The UV light source 160 may be coupled to the shelter frame 110. The UV light source 160 may emit UV light, which has been discussed in detail, above. In embodiments incorporating a UV light source 160, the power source 150 may be in operative communication with the UV light source 160. In some other embodiments, the UV light source 160 may have a power source that is separate from the power source 150 of the first airflow generator 140-1.

As discussed in detail above, the shelter frame 110 may be collapsible to a collapsed state and expandable to an erected state. FIG. 1 depicts an example erected state. In various embodiments, the shelter 100 defines the sheltered area 102 in the erected state. In some embodiments consistent with FIG. 1, in a collapsed state at least a portion of the frame members 112 are pivoted together about their ends to form a stacked configuration. In such a collapsed state, the shelter 100 does not necessarily define a sheltered area 102. As discussed above, the shelter frame 110 may be collapsible and expandable manually, by a motor drive, or both manually and by a motor drive.

In the current example, the plurality of the frame members 112 are coupled. In the current example, the plurality of frame members 112 are pivotably coupled to at least one pivot joint 170. In some such examples, each of the plurality of frame members 112 have a first end 114-1 pivotably coupled to a first pivot joint 170-1, and a second end 114-2 pivotably coupled to a second pivot joint 170-2. In the current example, the first pivot joint 170-1 is defined by the first airflow generator 140-1 and the second pivot joint 170-2 is defined by the second airflow generator 140-2. The first pivot joint 170-1 is positioned on one end of the sheltered area 102, and the second pivot joint 170-2 is positioned on an opposite end of the sheltered area 102. The first pivot joint 170-1 and the second pivot joint 170-2 may mutually define a pivot axis 10 of the plurality of frame members. In some such embodiments, the plurality of frame members 112 may be pivoted about the pivot axis 10 in a first direction to define an expanded configuration. The plurality of frame members may be pivoted about the pivot axis 10 in a second direction to define a collapsed position. Now the first pivot joint 170-1 will be described. The discussion of the first pivot joint 170-1 also applies to the second pivot joint 170-2.

In the current example, the first pivot joint 170-1 defines outer circumferential rails 172 about the body of the first airflow generator 140-1. The first end 114-1 of each of a plurality of frame members 112 is pivotably and translatably coupled to the rails 172 for collapse of the shelter 100 and expansion of the shelter 100.

The shelter 100 may have an air quality sensor 180 in a variety of embodiments, which is visible in FIG. 1. In the current example, the air quality sensor 180 is disposed in the sheltered area 102. Such a configuration may advantageously allow the shelter 100 to monitor air quality. The air quality sensor 180 may identify when the air quality is below a threshold, identify particular gaseous constituents in the air, or both identify when air quality is below a threshold and identify particular gaseous constituents in the air. The air quality sensor 180 may be in operative communication with the first airflow generator 140-1, the second airflow generator 140-2, or both the first airflow generator 140-1 and the second airflow generator 140-2. The air quality sensor 180 may be in operative communication with the airflow generator 140-1, 140-2 through a controller. In some embodiments, the air quality sensor 180 may operate the airflow generator 140-1, 140-2 upon sensing air quality that is below a threshold. In some such embodiments the air quality sensor 180 may operate the airflow generator 140-1, 140-2 upon detection of a particular constituent in the air. Such configurations may advantageously reduce energy that would otherwise be wasted to operate the airflow generator 140-1, 140-2 and other components when air filtration is unnecessary.

The shelter may have a communication module 190, in a variety of embodiments. The communication module 190 may be configured to inform a user of air quality in the sheltered area 102. The communication module 190 may be in data communication with the air quality sensor 180. The communication module 190 may include one or more user interfaces such as a screen, a speaker, and a wireless communication component. The user interface may have a variety of configurations and may have various components and combinations of components. The user interface may include a screen coupled to the air purification device. The screen may be configured to provide a visual notification to a user. The user interface may include a speaker coupled to the air purification device. The speaker may provide an audio notification to a user. The user interface may include a wireless communication component configured to communicate with a user device such as a laptop, smartphone, iPhone, speaker, or other devices. The user interface may send data directly to a user device, or to a database that may be accessed by a user or a home automation system through a network.

For the purpose of the present description and of the appended claims, except where otherwise indicated, all numbers expressing amounts, quantities, percentages, and so forth, are to be understood as being modified in all instances by the term “about”. Also, all ranges include the maximum and minimum points disclosed and include any intermediate ranges therein, which may or may not be specifically enumerated herein. In this context, therefore, a number A is understood as A ±5 percent of A. Within this context, a number A may be considered to include numerical values that are within general standard error for the measurement of the property that the number A modifies. The number A, in some instances as used in the appended claims, may deviate by the percentages enumerated above provided that the amount by which A deviates does not materially affect the basic and novel characteristic(s) of the claimed invention. Also, all ranges include the maximum and minimum points disclosed and include any intermediate ranges therein, which may or may not be specifically enumerated herein.

1. An air filtering shelter comprising:
a shelter frame comprising a plurality of frame members defining a sheltered area, wherein the frame members are rods;
a filter media extending across the plurality of frame members, wherein the filter media is disposed over the sheltered area;
an airflow guide extending across the plurality of frame members between the sheltered area and the filter media, wherein the airflow guide is impermeable and the filter media and the airflow guide define an airflow channel between them; and
an airflow generator coupled to the shelter frame, wherein the airflow generator has an inlet in the airflow channel and an outlet in the sheltered area.

2. The air filtering shelter of claim 1, wherein the shelter frame is collapsible to a collapsed state and expandable to an erected state.

3. The air filtering shelter of claim 2, wherein the shelter frame is manually collapsible and expandable.

4. The air filtering shelter of claim 2, wherein the shelter frame is collapsible and expandable by a motor.

5. The air filtering shelter of claim 2, wherein in the erected state the air filtering shelter defines the sheltered area.

6. The air filtering shelter of claim 1, wherein each of the plurality of frame members are pivotably coupled to at least one pivot joint.

7. The air filtering shelter of claim 1, wherein the filter media is coupled to an outer surface of one or more frame members and the airflow guide is coupled to an inner surface of one or more frame members.

8. The air filtering shelter of claim 1, wherein the filter media is detachable from the plurality of frame members.

9. The air filtering shelter of claim 1, further comprising an ultraviolet (UV) light source configured to emit UV light into the airflow channel.

10. The air filtering shelter of claim 1, further comprising a rechargeable power source in operative communication with the airflow generator.

11. The air filtering shelter of claim 1, further comprising an air quality sensor disposed in the sheltered area, wherein the air quality sensor is in operative communication with the airflow generator.

12. The air filtering shelter of claim 1, further comprising a filter element coupled to the airflow generator about the inlet.

13. The air filtering shelter of claim 1, wherein the air filtering shelter defines a canopy.

14. The air filtering shelter of claim 1, wherein the air filtering shelter defines a tent.

15. A method of filtering air with the air filtering shelter of claim 1 comprising:
drawing air through the filter media into the airflow channel defined between the filter media and the airflow guide; and
passing the air from the airflow channel through the airflow generator to the sheltered area defined by the airflow guide.
